(19) United States
(12) Patent Application Publication
(10) Pub. No.: US 2014/0229912 A1
(43) Pub. Date: Aug. 14, 2014

(54) MICRO DOCUMENTATION ENVIRONMENTS

(71) Applicant: MICROSOFT CORPORATION, Redmond, WA (US)

(72) Inventors: Andre Wilson Brotto Furtado, Kirkland, WA (US); Bryan C. Wintermute, Bellevue, WA (US); Roberto Sonnino, Seattle, WA (US); Sebastian Rodriguez Bojorge, Mexico City D.F. (MX); Sven Oliver Szimmetat, Beijing (CN); Tamás Sorosy, Redmond, WA (US)

(73) Assignee: MICROSOFT CORPORATION, Redmond, WA (US)

(21) Appl. No.: 13/763,260

(22) Filed: Feb. 8, 2013

(51) Int. Cl. G06F 9/44

(52) U.S. Cl. CPC G06F 8/73
USPC 717/120

(57) ABSTRACT

Systems, methods, and software are disclosed for facilitating micro documentation environments. In at least one implementation, a micro documentation environment includes subject entities within a micro blogging environment. At least one subject entity corresponds to at least one software component within a software development environment. The micro documentation environment also includes other entities within the micro blogging environment. At least one other entity follows the one subject entity corresponding to the software component. The micro documentation environment also includes micro posts, at least one of which is generated on behalf of the one subject entity and comprises documentation information related to the one software component.

### TECHNICAL FIELD

Aspects of the disclosure are related to computing and communications technology, and in particular, to micro blogging and micro documentation environments.

### TECHNICAL BACKGROUND

Software documentation is a process that involves explaining various aspects of a software solution and its development process to facilitate understanding of the solution. Software documentation is traditionally accomplished by creating specifications that can be regularly updated with knowledge about the software under development. The specifications can then be accessed when questions arise that might be addressed by the documented knowledge. In an example, a developer may access a specification to learn about features provided by a component or design limitations of a component.

In addition to documentation specifications, a variety of tools exist to track discrete information about the various software components or other development entities. For example, many software development environments include component databases that store the identity of each component within a solution, the identity of a developer associated with the component, and the most recent status of the component. Developers can access the database to inquire about a particular component or related bugs and tests as needed.

Some developers also utilize micro blogging services to track and obtain information relevant to the development of a software solution. For example, developers on a team may follow each other, allowing them to post short hints or other pieces of information about their work on a component or other development entity. In this manner helpful information can be distributed quickly throughout a development organization.

### OVERVIEW

Provided herein are systems, methods, and software for facilitating micro documentation environments. In at least one implementation, subject entities are hosted within a micro blogging environment. The subject entities include at least one subject entity that corresponds to a software component within a software development environment. Other entities are also hosted within the micro blogging environment, including a user entity configured to follow the subject entity. Micro posts are generated and distributed within the micro blogging environment, at least one of which is a micro post generated on behalf of the subject entity and that includes documentation information related to the software component.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a micro documentation environment in an implementation.

FIG. 2 illustrates a micro documentation process in an implementation.

FIG. 3 illustrates a computing system in an implementation.

FIG. 4 illustrates a micro documentation environment in an implementation.

FIG. 5 illustrates a view of a micro blogging environment employing micro documentation in an implementation.

FIG. 6 illustrates an operational sequence involving a view of a micro blogging environment in an implementation.

FIG. 7 illustrates an operational sequence involving a view of a micro blogging environment in an implementation.

FIG. 8 illustrates a micro documentation process in an implementation.

FIG. 9 illustrates a micro documentation process in an implementation.

FIG. 10 illustrates a micro documentation process in an implementation.

FIG. 11 illustrates an operational sequence in an implementation.

FIG. 12 illustrates an operational sequence in an implementation.

FIG. 13 illustrates a productivity application having micro documentation capabilities in an implementation.

### TECHNICAL DISCLOSURE

Implementations described herein provide for improved documentation for software development processes. Micro documentation technologies are utilized to allow users to engage in the documentation process in an online, collaborative and social manner. This allows users to efficiently capture and retrieve structured or unstructured documentation information related to various elements or development entities associated with a software development environment, such as components or other aspects of a component, such as bugs and test jobs. Applying micro documentation to the documentation process allows for fine-grained pieces of knowledge to be retained and shared throughout an organization.

Some implementations disclosed herein may be applicable to other fields in addition to software documentation. For instance, such micro documentation technologies disclosed herein may be used to efficiently capture and retrieve structured or unstructured documentation information related to various elements associated within a research development environment, such as papers and experiments. Within a financial services environment such micro documentation technologies may be used to capture and retrieve documentation information related to financial entities, such as individual stocks, mutual funds, financial projects, and the like. Within a medical environment such micro documentation technologies may be applied to medical entities, such as particular diseases, particular healthcare providers, particular procedures, or any other type of medical-related entity. Thus, the scope of the present disclosure may encompass a wide variety of documentation applications, environments, and information and need not be limited to software documentation.

In at least one implementation, a micro documentation environment is provided in which documentation information associated with a software development environment is communicated for distribution within a micro blogging environment. Some entities within the micro blogging environment, followed by other entities, may be associated with at least some of the components being developed or documented within the software development environment. The documentation information can be distributed on behalf of the associated entities by way of micro posts intended for consumption by the other entities. In this manner, end users associated with the other entities are able to gain and exchange knowledge about the various software components in the development environment, thereby improving the software development process.

Some of the entities created and followed within the micro blogging environment may correspond directly to a software component. Users interested in the software component may, via their corresponding entity within the micro blogging environment, request to follow the subject entity corresponding to the software component. Documentation information related to the software component, such as a status update, may be posted within the micro blogging environment and made available for consumption via the user's feed or channel on behalf of the subject entity. In addition, the user or other users may post other information, such as comments, links to articles, and the like, to the micro blog, feed, or any other channel associated with the subject entity. The various posts and assorted information can be consumed in real-time but may also be stored and archived for later searching.

In some implementations, some of the entities created and followed within the micro blogging environment may correspond to development entities other than a software component but that are related to a software component. For example, a given software component may have an associated bug or test which may be considered development entities associated with the software component. The software component may itself be considered one type of development entity.

A subject entity may be created that corresponds to the bug or test, and thus corresponds indirectly to the software component. Users interested in the bug or test may, via their corresponding user entity within the micro blogging environment, request to follow the subject entity corresponding to the bug. Documentation information related to the bug or test, such as whether or not it has been fixed or executed, may be posted for consumption via the user's feed or delivered via any other channel or aspect of the micro blogging environment, such as the micro blog associated with the subject entity. As mentioned, the user or other users may post other information, such as comments, links to articles, and the like, to the micro blog associated with the subject entity and the various posts and assorted information can be consumed in real-time but may also be stored and archived for later searching.

Other aspects found in some implementations include the ability to search for and follow a category of entities. For example, a user may have interest in not just a given software component, but also sub-components, earlier or next versions of the component, or any other category to which the given component may belong. In another example of a category, a user may have an interest in any bug associated with a given software component or any test associated with a given software component. In any of these cases, the user may, by way of their user entity in the micro blogging environment, request to follow entities within a category. In the event that entities exist that fall into the category, the user's entity is registered as a follower of those entities. It may also be possible to continuously monitor for additional entities that qualify under the category such that the user's entity may be subsequently registered as a follower. It may also be the case that no entities exist that fall into the category, in which case monitoring may be performed to detect the creation of such entities at a later time, at which time the user's entity may be registered as a follower.

Some scenarios utilize a particular naming syntax when naming entities within the micro blogging environment. The naming syntax describes how to name each subject entity that is created and includes a type portion and a component portion. The type portion describes to which of a several types a given subject entity may correspond while the component portion describes to which development entity, such as a software component, a medical study, or the like the given subject entity corresponds. In some cases the component portion is preceded by the type portion, although the order may vary.

In some implementations, the type portion in the naming syntax comprises an initial character and the component portion in the naming syntax comprises a string. It may be appreciated that it is possible for the type portion to comprise one or more characters. In addition, the type portion need not always be the initial character. The types may include a feature or component type, a bug type, and a test type, and the initial character may be a different symbol for each of the different types. In some scenarios the naming syntax involves a group portion that describes to which of a several groups of software components each of the subject entities corresponds.

For example, the name of each subject entity may be prefixed with a character that establishes what type of software component or other element the subject entity corresponds to. Prefixing the name with an “at” symbol (@) identifies an entity as associated with a person, while prefixing the name with a dollar symbol ($) identifies an entity as associated with a software component. Along the same lines, prefixing the name with an asterisk symbol (*) identifies an entity as a bug associated with a software component, while prefixing the name with a caret symbol (̂) identifies an entity as a test job associated with a software component. It may be appreciate that a variety of other conventions may be utilized with a respect to the syntax such that entities can be identified as associated with various types of components or elements.

The aforementioned syntax allows systems and sub-systems within the micro blogging environment to tailor certain behaviors on a per-entity basis. For example, a system involved with displaying a profile for a given entity of a given type as indicated by its prefix may tailor the display of the profile to match a template associated with that type. In another example, a system involved with handling a user search on a given entity of a given type may search one data store over another based on the symbol prefixed to the name of the given entity. In another example, the prefix of an entity's name may at least partially contribute to the determination of which data sources within a software development environment to access to obtain documentation information. For instance, status data on software components may be stored in one repository or logical storage environment while information pertaining to a bug or test job may be kept elsewhere.

In yet another example, the syntax in certain systems describes the relationship between the different types of entities and as such their collective behavior. For example this allows users to follow a given type of entity, or entities associated with it whether already created, or will be created at a later time. In another example this also allows the system to make internal decisions based on this relationship, for example when displaying the profile of a software component, it can display information about micro blog entries that contain information about bugs or tests that are associated with this software component. In some implementations when following bugs, the system may allow for following severity or priority rating for any bugs or a subset of bugs. For example, a user may be allowed to follow bugs meeting or exceeding a particular severity level for a particular component, or all bugs assigned to a particular tester or developer.

An auto-complete feature may be provided in some implementations to auto-complete a query entered by a user by translating at least a portion of a string describing a software component to a corresponding entity identifier named in accordance with the naming syntax. In particular, the component portion of the entity identifier may be a component identifier, such as a serial number, with which to access the information related to the software component.

In some implementations auto-generation of micro blog entries or posts may be triggered by an internal event in the micro documentation environment, or an external event that the environment is connected to. For example, when a bug status is changed in a bug data store, the micro documentation environment may create a micro documentation entry that documents this change, and all the users who follow that bug or entities associated with the bug could be notified of the change in the status of the bug.

In at least one deployment a tool is provided within a software application that allows users of the software application to post comments on a feature of the application to the micro blog associated with that feature. In an example, a productivity application may include various features, such as an insert, save, or formatting feature. As users experience the features they may wish to provide feedback to the developer of the feature or other people that follow an entity corresponding to the feature within a micro blogging environment. The tool integrated within the software application can accept the user's comments and communicate them back to the micro blogging environment for posting by way of feeds, the micro blog, or the like.

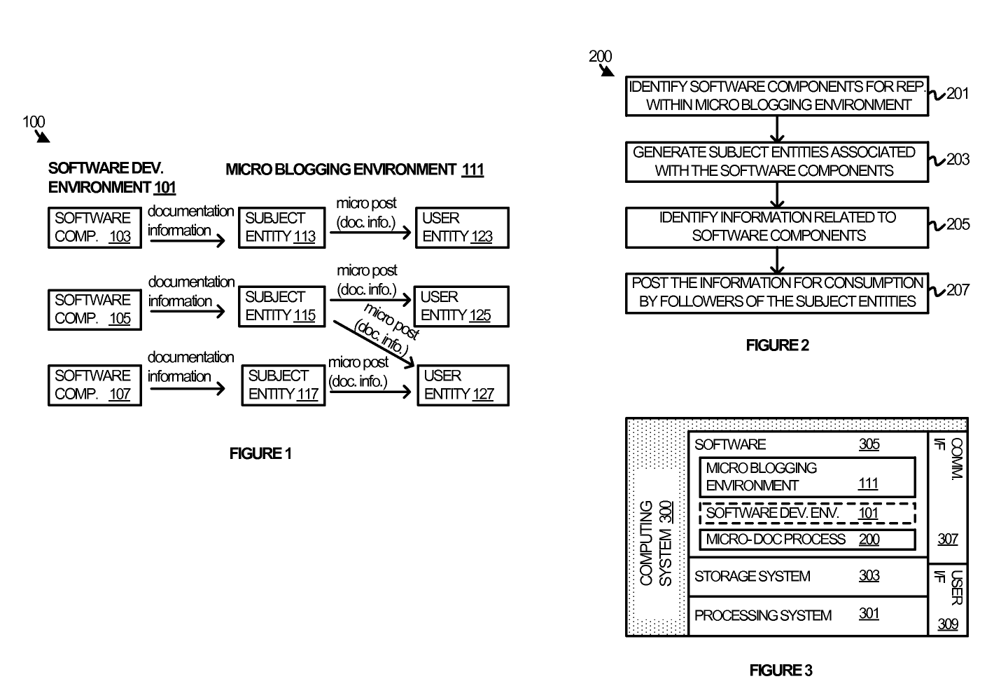

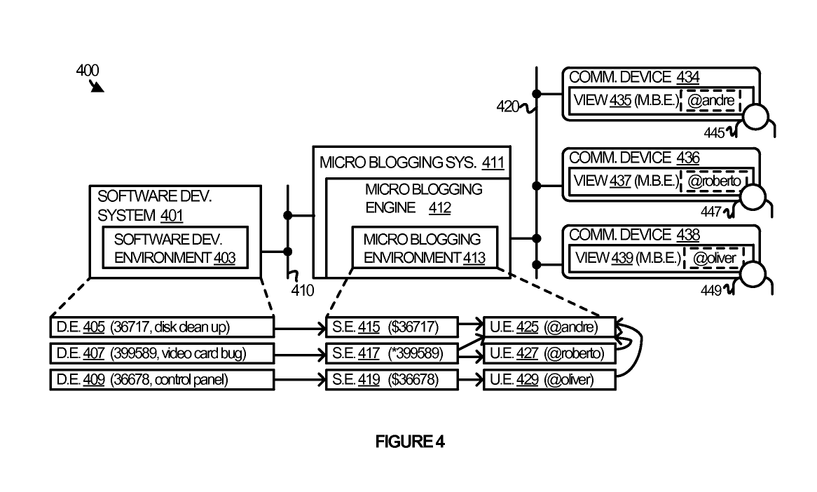

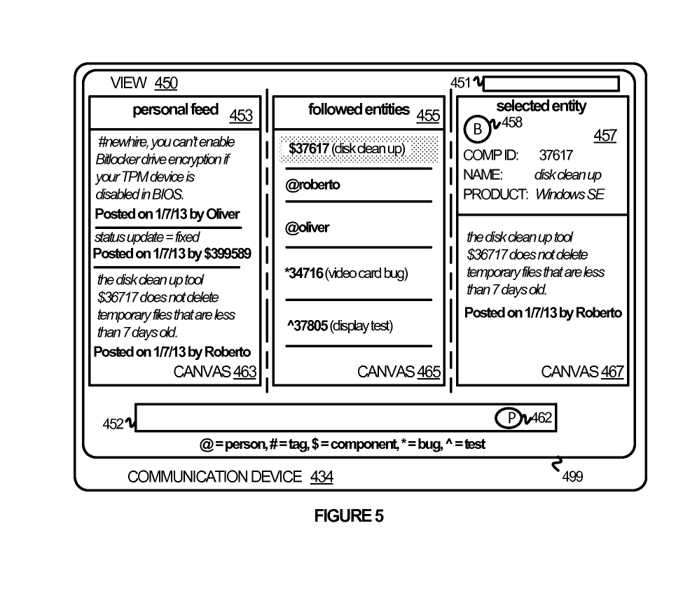

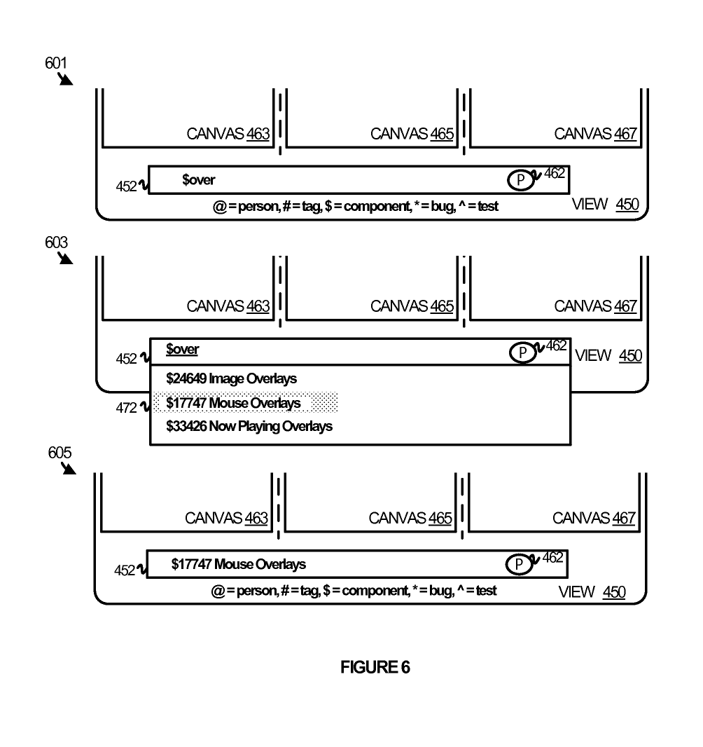

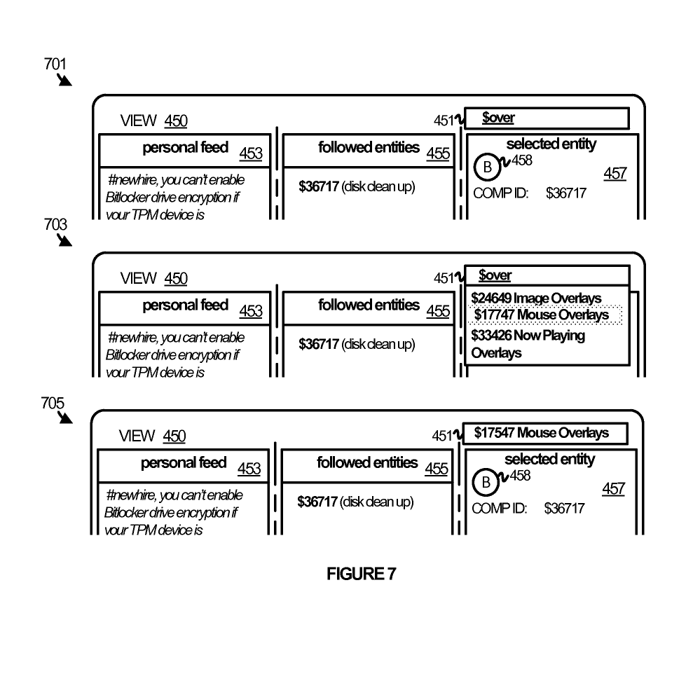

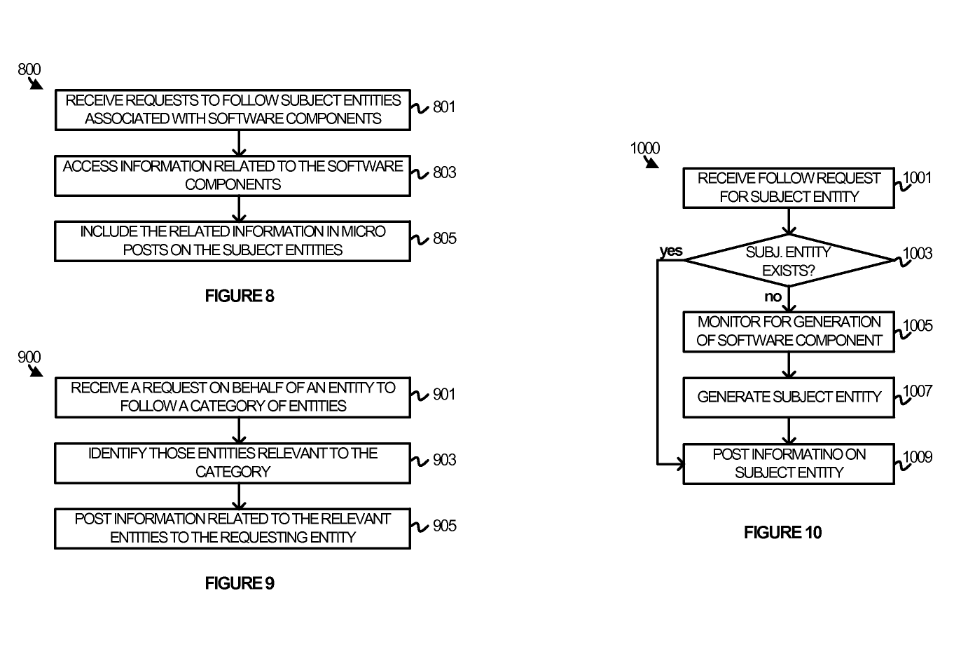

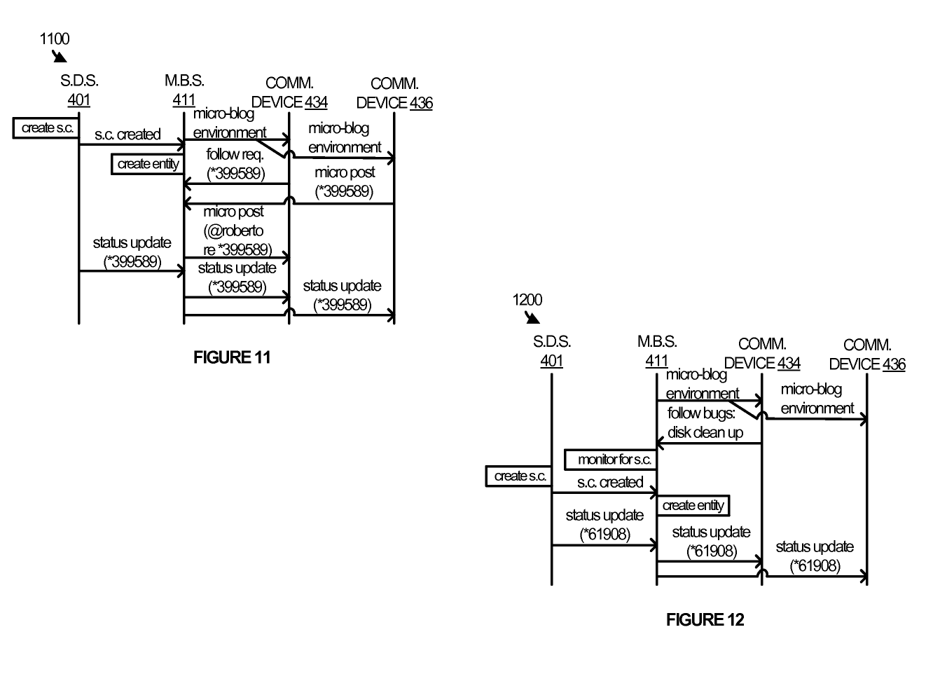

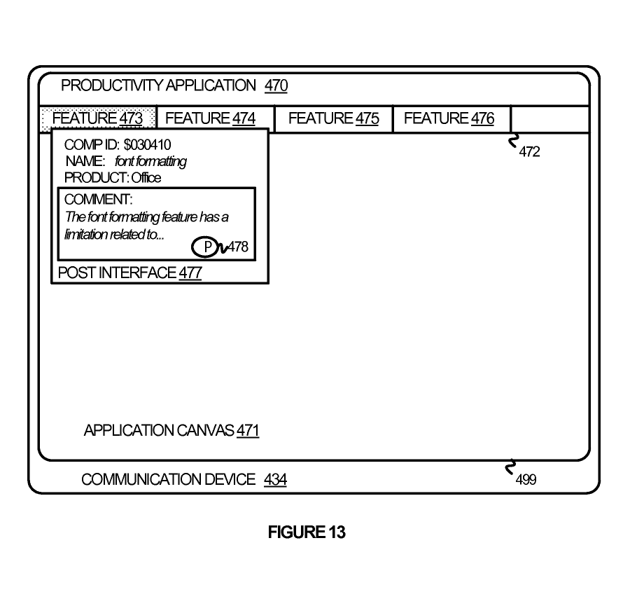

Turning now to the drawings, FIG. 1 illustrates a micro documentation environment, while FIG. 2 illustrates a micro documentation process that may be implemented with respect to the micro documentation environment. FIG. 3 illustrates a computing system suitable for implementing at least a portion of the micro documentation environment and the micro documentation process. FIG. 4 illustrates another micro documentation environment, while FIG. 5 illustrates a view of a micro blogging environment. FIG. 6 and FIG. 7 illustrate two operational sequences involving the view. FIGS. 8-10 illustrate various micro documentation processes and FIGS. 11-12 illustrate two operational sequences. FIG. 13 illustrates a productivity application having micro documentation capabilities. FIG. 14 illustrates a communication device representative of a device that may be employed in a micro documentation environment.

Referring to FIG. 1, micro documentation environment 100 includes software development environment 101 and micro blogging environment 111. Software development environment 101 may be any environment in which software components are developed and documented. Micro blogging environment 111 may be any environment capable of supporting entities, allowing entities to follow other entities and be followed by other entities. Examples of micro blogging environments include those provided by the Yammer®, Tumblr, SharePoint®, and Twitter services, as well as those provided within social network services, such as Facebook and Google+.

Software development environment 101 includes software component 103, software component 105, and software component 107. Software component 103, software component 105, and software component 107 may each be a representative of any component or group of components that may be developed as part of a software solution, software product, software environment, or the like. Software component 103, software component 105, and software component 107 may each also be a representative of any test, bug, or other subject associated with any component or group of components that may be developed as part of a software solution, software product, software environment, or the like. Software development environment 101 may include various systems and sub-systems capable of hosting documentation information related to the software components developed therein.

Micro blogging environment 111 includes subject entity 113, subject entity 115, and subject entity 117. Subject entity 113, subject entity 115, and subject entity 117 may each be representative of any entity with micro blogging environment 111 that can be followed by other entities and that is associated with a software component or components within software development environment 101. In this implementation, subject entity 113 is associated with software component 103, subject entity 115 is associated with software component 105, and subject entity 117 is associated with software component 107, although it may be appreciated that other associations are possible.

Also included in micro blogging environment 111 are user entity 123, user entity 125, and user entity 127. User entity 123, user entity 125, and user entity 127 may each be representative of any entity within micro blogging environment 111 that can follow other entities on behalf of a user, such as subject entities 113, 115, and 117 or each other, and possibly be followed by other entities. In this implementation, user entity 123 follows subject entity 113, user entity 125 follows subject entity 115, and user entity 127 follows both subject entity 115 and subject entity 117. These associations are illustrated merely for exemplary purposes and it may be appreciated that other associations and arrangements of followed and following entities are possible.

FIG. 2 illustrates a micro documentation process 200 for facilitating micro documentation environment 100. In operation, software components within software development environment 101 are identified for representation within micro blogging environment 111 as subject entities that can be followed (step 201). In this example, software components 103, 105, and 107 are identified for representation. This may be accomplished by, for example, accessing and processing a table or other data structure that stores the identity of software components, and possibly other development entities, in association with their corresponding subject entity, if one exists. The data structured may be created and maintained in a manual or automatic manner or in any variation or combination thereof. The data structure may be created and maintained entirely or in part by software development environment 101 or micro blogging environment 111 or both.

Next, subject entities are created within micro blogging environment 111 that correspond to or are associated with the identified software components (step 203). The subject entities are created for those components identified using the data structure referenced above. In this example, subject entities 113, 115, and 117 are created accordingly.

Once subject entities 113, 115, and 117 are created, communication between micro blogging environment 111 and software development environment 101 is initiated to access documentation information related to each of the identified software components (step 205). The documentation information is then posted for consumption by followers of each of the subject entities associated with each of the identified software components (step 207). In this example, a micro post with documentation information related to software component 103 is published on behalf of subject entity 113 for consumption by user entity 123. In addition, a micro post with documentation information related to software component 105 is published on behalf of subject entity 115 for consumption by user entity 125 and user entity 127. Lastly, a micro post with documentation information related to software component 107 is published on behalf of subject entity 117 for consumption by user entity 127. In this manner, people associated with software components 103, 105, and 107 may learn about, use, or otherwise benefit from the documentation information gathered from software development environment 101 and posted within micro blogging environment 111.

FIG. 3 illustrates computing system 300, which may be representative of any computing apparatus, system, or collection of systems suitable for implementing all or portions of micro documentation environment 100, such as micro blogging environment 111 and optionally software development environment 101. Computing system 300 may also be suitable for implementing all or portions of micro documentation process 200. Examples of computing system 300 include general purpose computers, server computers, cloud computing platforms, data centers, virtual computing platforms, or distributed computing platforms, as well as any variation or combination thereof.

Computing system 300 includes processing system 301, storage system 303, software 305, communication interface 307, and user interface 309. Processing system 301 is operatively coupled with storage system 303, communication interface 307, and user interface 309. Processing system 301 loads and executes software 305 from storage system 303. When executed by computing system 300 in general, and processing system 301 in particular, software 305 directs computing system 300 to operate as described herein for micro documentation process 200 or variations thereof. Computing system 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variations thereof.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301.

Software 305 may be implemented in program instructions and among other functions may, when executed by computing system 300 in general or processing system 301 in particular, direct computing system 300 or processing system 301 to operate as described herein for micro documentation process 200. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform computing system 300 overall from a general-purpose computing system into a special-purpose computing system customized to facilitate micro documentation environments or portions thereof as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 300 is generally intended to represent a computing system with which software 305 is deployed and executed in order to implement micro documentation process 200 (and variations thereof) and optionally all or portions of micro documentation environment 100. However, computing system 300 may also represent any computing system on which software 305 may be staged and from where software 305 may be distributed, transported, downloaded, or otherwise provided to yet another computing system for deployment and execution, or yet additional distribution.

Referring again to FIG. 1 and FIG. 2, through the operation of computing system 300 employing software 305, transformations may be performed with respect to micro documentation environment 100. As an example, micro documentation environment 100 could be considered transformed from one state to another when subject to micro documentation process 200 or variations thereof. In a first state, subject entities corresponding to some software components may not yet exist. In a second state, the subject entities may be generated, thereby changing micro documentation environment 100 to a different state. In yet another state, documentation information related to the software components may be posted on behalf of the subject entities by other entities that follow the subject entities.

Referring again to FIG. 3, communication interface 307 may include communication connections and devices that allow for communication between computing system 300 and other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface 309, which is optional, may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface 309. The aforementioned user interface components are well known and need not be discussed at length here.

FIG. 4 illustrates micro documentation environment 400 in an implementation. Micro documentation environment 400 includes software development system 401, micro blogging system 411, communication device 434, communication device 436, and communication device 438. Software development system 401 and micro blogging system 411 communicate over communication link 410. Micro blogging system 411 communicates with communication device 434, 436, and 438 over communication link 420. Note that communication link 410 and communication link 420 may be separate and distinct links but may also be integrated or overlap with each other to at least some degree.

Software development system 401 may be any system or collection of systems capable of hosting all or portions of a software development environment. Software development system 401 may implemented using any suitable computing, such, of which computing system 300 may be representative, capable of storing and executing software and documentation information, communicating with micro blogging system 411, and the like. Software development environment 403 may be any environment in which software components are developed and documented.

Micro blogging system 411 may be any system or collection of systems capable of hosting all or portions of a micro blogging environment and communicating with client devices to allow for their interaction with a micro blogging environment. Micro blogging system 411 may be implemented using any suitable computing system, or which computing system 300 is representative, capable of storing and executing software, hosting a micro blogging environment, and communicating with software development system 401 and communication devices 434, 436, and 438,

Micro blogging system 411 includes micro blogging engine 412 which is executed to render and operate micro blogging environment 413. Micro blogging engine 412 may be implemented in program instructions or other suitable computer executable code, of which software 305 is representative. When executing micro blogging engine 412, micro blogging system 411 operates as described herein with respect to micro documentation processes 800, 900, and 1000 illustrated in FIGS. 8-10. In addition, when executing micro blogging engine 412, micro blogging system 411 operates as described herein with respect to operational sequences 1100 and 1200 illustrated in FIGS. 11-12. Micro blogging environment 413 may be any environment capable of supporting entities, allowing entities to follow other entities and be followed by other entities.

Communication device 434, 436, and 438 may each be any type of communication device capable of supporting views 435, 437, and 439 of micro blogging environment 413. Examples of such communication devices include desktop computers, laptop computers, tablet computers, notebook computers, mobile phones, personal digital assistants, table computers, gaming devices, and Internet appliances, as well as any other type of device, variation of device, or combinations thereof. The various views of micro blogging environment 413 may be provided in a variety of ways, such as through web browsing applications, mobile applications, dedicated applications, or any variation or combination thereof.

Communication link 410 may be any link over which software development system 401 and micro blogging system 411 may communicate. In some examples, communication link 410 may be representative of a network or collection of networks, such as an intranet, the Internet, a local area network, a wide area network, a wireless network, a wired network, or any combination or variation thereof. In other examples, software development system 401 and micro blogging system 411 may be implemented in an integrated manner such that communication link 410 is representative of an inter-system link, such as an internal communication bus. In any case, communication link 410 may include connections, devices, and communication media, such as metal, glass, air, or any other suitable communication media over which documentation information and other information may be exchanged. The aforementioned communication media, network, connections, and devices are well known and need not be discussed at length here.

Communication link 420 may be any link over which micro blogging system 411 may communicate with communication devices 434, 436, and 438. In some examples, communication link 420 may be representative of a network or collection of networks, such as an intranet, the Internet, a local area network, a wide area network, a wireless network, a wired network, or any combination or variation thereof. Communication link 420 may include various connections, devices, and communication media, such as metal, glass, air, or any other suitable communication media, over which information may be exchanged, including micro posts, micro blogs, feeds, and views of micro blogging environments. The aforementioned communication media, network, connections, and devices are well known and need not be discussed at length here.

In operation, users 445, 447, and 449 engage with communication devices 434, 436, and 438 respectively in order to interact with views 435, 437, and 439 of micro blogging environment 413. In this implementation, it is assumed for exemplary purposes that each user has an associated user entity or identity within micro blogging environment 413 that they use to follow other entities or be followed themselves. User 445 is associated with user entity 425 represented by the entity name “@andre.” User 447 is associated with user entity 427 represented by the entity name “@roberto.” Finally, user 449 is associated with user entity 429 represented by the entity name “@oliver.”

Further in operation, various development entities may be tracked or developed within software development environment 403, such as software components, bugs associated with the components and test jobs, as well as any other kind of development entity. For exemplary purposes development entities (D.E.) 405, 407, and 409 are illustrated. Each development entity has a name and a component identifier. In some scenarios the name may be what is used by developers or other people when discussing the component, bug, test, or the like, while the component I.D. may be a numerical identifier with which to track the component, bug, or test and otherwise identify the development entity in a precise, persistent way. In this implementation, development entity 405 is a disk clean up component and its component I.D. is 36717. Development entity 407 is a video card bug and its component I.D. is 399589. Development entity 409 is a control panel component and its component I.D. is 36678.

Each development entity may have a corresponding subject entity within micro blogging system 411. The corresponding subject entity may be created under a variety of circumstances, such as in an automated fashion when its corresponding development entity is created. Some subject entities may be created on a per-request basis or at the prompting of some user or developer. Other circumstances under which subject entities may be created are possible and may be considered within the scope of the present disclosure. In this example, development entity 405 corresponds to subject entity 415, development entity 407 corresponds to subject entity 417, and development entity 409 corresponds to subject entity 419.

It may be appreciated from FIG. 4 that subject entities 415, 417, and 419 each have a name that complies with a particular naming syntax, although other syntaxes are possible and may be considered within the scope of the present disclosure. The naming syntax describes how to name each entity that is created and includes a type portion and a component portion. The type portion describes to which of a several types a given subject entity may correspond while the component portion is preceded by the type portion and describes to which software component the given subject corresponds. Referring still to FIG. 4, subject entity 415 is named $36717 to represent the type and name of development entity 405, subject entity 417 is named *399589 to represent the type and name of development entity 407, and subject entity 419 is named $36678 to represent the type and name of development entity 409.

In this implementation, the type portion in the naming syntax comprises an initial character and the component portion in the naming syntax comprises a string. The types may include a feature type, a bug type, and a test type, and the initial character may be a different symbol for each of the different types. In some scenarios the naming syntax involves a group portion that describes to which of a several groups of software components each of the subject entities corresponds.

For example, the name of each entity may be prefixed with a character that establishes what type of software component or other element the entity corresponds to. Prefixing the name with an “at” symbol (@) identifies an entity as associated with a person, while prefixing the name with a dollar symbol ($) identifies an entity as associated with a software component. Along the same lines, prefixing the name with an asterisk symbol (*) identifies an entity as a bug associated with a software component, while prefixing the name with a caret symbol (̂) identifies an entity as a test job associated with a software component. It may be appreciate that a variety of other conventions may be utilized with a respect to the syntax such that entities can be identified as associated with various types of components or elements.

The aforementioned syntax allows systems and sub-systems within the micro blogging environment to tailor certain behaviors on a per-entity basis. For example, a system involved with displaying a profile for a given entity of a given type as indicated by its prefix may tailor the display of the profile to match a template associated with that type. In another example, a system involved with handling a user search on a given entity of a given type may search one data store over another based on the symbol prefixed to the name of the given entity. In another example, the prefix of an entity's name may at least partially contribute to the determination of which data sources within a software development environment to access to obtain documentation information. For instance, status data on software components may be stored in one repository or logical storage environment while information pertaining to a bug or test job may be kept elsewhere.

FIG. 4 also illustrates some basic behaviors that may be possible within micro blogging environment 413 and that are illustrated in more detail with respect to FIG. 10. In FIG. 4, user entity 425 is a follower of subject entity 415 and subject entity 417, user entity 427, and user entity 429. In other words, user 445 (Andre) is interested in following the disk clean up software component, the video card bug, Roberto, and Oliver. User entity 427 is illustrated as following subject entity 417 while user entity 429 is illustrated as following subject entity 419. In other words, user 447 (Roberto) follows the video card bug while user 449 (Oliver) follows the control panel component.

In operation, micro blogging engine 412 drives micro blogging system 411 to communicate with software development system 401 to access or otherwise obtain documentation information or other information on development entities 405, 407, and 409. Micro blogging system 411 retrieves the information and micro blogging engine generates micro posts that incorporate at least portions of the information. For example, micro blogging engine 412 may populate a micro blog associated with subject entity 415 with documentation information on development entity 405. User 445 may then read micro blog as presented through view 435 of micro blogging environment 413. In another example micro blogging engine 412 may incorporate the documentation information within a micro post published to a news feed associated with user entity 425 such that the documentation information can be consumed by user 445. A variety of ways to publish or deliver documentation information and other information are possible and may be considered within the scope of this disclosure.

Similarly, user 447 by way of user entity 427 may post a comment, article or other information. The post may or may not be associated with subject entities followed by user 445. Regardless, because user entity 425 is registered as a follower of user entity 427, the post can be delivered to view 435 for consumption by user 445. For instance, the post may be published to a news feed presented within view 435. A similar operation may occur with respect to posts generated on behalf of user entity 429.

In some situations posts made by other entities, even when not followed by a given entity, may be posted to a micro blog associated with yet another entity that is followed by the given entity. In such a situation the given entity may receive the post within the context of the micro blog associated with the other entity. For example, if another entity not followed by user 445 (Andre) were to post a comment on the micro blog associated with subject entity 415, that post may be presented to user 445 via view 435 of micro blogging environment 413 because subject entity 415 is followed by user entity 425. This is a well-known behavior within micro blogging technology and need not be discussed at length here.

FIG. 5 illustrates view 450 of micro blogging environment 413. View 450 is representative of views 435, 437, and 439 illustrated in FIG. 4. View 450 may be presented by communication device 434 or any other similar device within the context of an application, such as a web browser, a mobile application, a dedicated application, or any other variation or combination thereof. View 450 is presented by display 499 which may be, for example, a screen, a touch screen or any other kind of surface capable of displaying a view. View 450 may be rendered entirely or partially by micro blogging engine 412 and communicated to communication device 434 for display. Alternatively, view 450 may be rendered entirely or partially by communication device 434. A wide variety of rendering technology and delivery technology are possible and may be considered within the scope of this disclosure.

View 450 includes search tool 451 that allows a user to search for information within micro blogging environment 413. View 450 also includes a posting tool 452 that allows a user to post comments, links, or other information with respect to other entity followed by the user. The user may type or otherwise input information into the posting tool 452 and then select the post button 462 to initiate communication of the post to micro blogging environment 413. The post may then be distributed for consumption by other entities that follow the posting entity or that follow the entity that is the subject of the post.

In this implementation, view 450 includes three visible areas or decks that each correspond to a different aspect of micro blogging environment 413. For example, deck 453 is a representation of a personal feed within which micro posts are presented on behalf of entities followed by user 445. The posts are presented over canvas 463, Because user 445 follows user 449, micro posts generated on behalf of user 449 (Oliver) are delivered through the personal feed. Similarly, a post by user 447 (Roberto) is also delivered through the personal feed. Note that a micro post generated on behalf of subject entity 417 (entity name $399589) is presented within the personal feed. This is because subject entity 417 is followed by user entity 425 associated with user 445. The documentation information communicated in this post—that a bug has been fixed—is obtained by micro blogging system 411 from software development system 401.

Deck 455 is a representation of some of the entities that may be followed by a user. In this example, user 445 is illustrated as following at least $36717 (disk clean up), @roberto, @oliver, *34716 (video card bug), and an entity not illustrated in FIG. 4-̂37805, which corresponds to a display test job. The entities followed by user 445 via his corresponding user entity 425 are display on canvas 465.

User 445 may provide a selection or other similar input to communication device 434 to select one of the entities for more detailed viewing in deck 457. In this implementation, it is assumed that the identifier $36717 is selected. Thus, deck 457 illustrates profile information for the 37617 component corresponding to the $36717 entity. For example, the profile includes the component I.D., component name, and product to which the component belongs. The profile also includes a graphic 458 that represents the type of the entity, which in this case is a bug. Recent posts or other information associated with the bug can be displayed over canvas 467.

FIG. 6 illustrates an operational sequence involving view 450. In particular, an auto-translate operation is illustrated within the context of user 445 generating a post. In this example, user 445 has typed a partial string of $over (step 601). The auto-completion feature reads the string and provides a list of possible subject entities that may correspond to the partial string (step 603). For exemplary purposes the list includes an Image Overlays component, a Mouse Overlays component, and a Now Playing Overlays component. Note how the auto-completion feature also included an entity name for each of the components. User 445 selects the $17747 Mouse Overlays component and can then type additional comments or other text for posting using post button 462 (step 605).

FIG. 7 illustrates a similar operational sequence involving view 450, but with respect to search tool 451. In this example, the auto-translate operation is illustrated within the context of user 445 initiating a search query. In this example, user 445 has typed a partial string of $over (step 701). The auto-completion feature reads the string and provides a list of possible subject entities that may correspond to the partial string (step 703). For exemplary purposes the list includes an Image Overlays component, a Mouse Overlays component, and a Now Playing Overlays component. Note how the auto-completion feature also included an entity name for each of the subject entities. User 445 selects the $17747 Mouse Overlays component and can then type additional comments or other text for posting using post button 462 (step 705).

FIG. 8 illustrates a micro documentation process 800 in an implementation. Micro documentation process 800 is representative of some processes that may be performed by micro blogging system 411 when executing micro blog engine 412.

In operation, micro blogging system 411 receives requests to follow subject entities that are associated with development entities (step 801). For example, user 445 operating communication device 434 to engage with view 435 may prompt communication device 434 to communicate a request on behalf of user entity 425 to follow a software component, such as the display test referenced with respect to FIG. 5. The display test is a test job having and has an entity name of ̂37805. User entity 425, otherwise known as @andre, is therefore registered within micro blogging environment as a follower of ̂37805.

Once @andre is established as a follower of ̂37805, micro blogging system 411 communicates periodically or on some other basis with software development system 401 to access documentation information or other information related to the display test job (step 803). For example, micro blogging system 411 may communicate in accordance with an application programming interface (API) designed to facilitate queries to software development system 401. Alternatively, software development system 401 may periodically or on some other basis initiate communications with micro blogging system 411 to provide such documentation information.

Having obtained the information related to the display test, micro blogging system 411 includes the related information in a micro post associated with entity ̂37805 (Step 805). For example, a micro post with the result or status of the display test may be posted to a feed associated with @andre, posted to a micro blog on the home page for ̂37805, or otherwise made available.

FIG. 9 illustrates another micro documentation process 900 in an implementation. Micro documentation process 900 is also representative of some processes that may be performed by micro blogging system 411 when executing micro blog engine 412.

In operation, micro blogging system 411 receives a request to follow a category of subject entities that may be associated with various development entities (step 901). For example, user 445 operating communication device 434 to engage with view 435 may prompt communication device 434 to communicate a request on behalf of user entity 425 to follow any entities that fall into a particular group, such as all versions of a component, all sub-components of a component, all bugs associated with a particular component, or all tests associated with a component. In addition, a category may be defined as all bugs of a certain type, all tests of a certain type, or any combination or variation thereof. It may be appreciated that a wide variety of categories are contemplated and are not limited to just those disclosed herein.

How a category is selected, defined, or otherwise communicated can be accomplished in a variety of ways. In some cases categories may be selected from a menu, for example. In other cases, a naming syntax for naming entities may allow for category descriptions. For example, suffixes added to entity names in follow requests could be used to define a category of entities. In one example the characters “>>” added as a suffix to an entity name for a subject entity or some variation thereof could be used to indicate that a related component and any subsequent versions of the component are desired to be followed. Using an example from above for illustrative purposes, a user may wish to follow the disk clean up component and any next versions of it. Accordingly, a follow request may include the entity name for the component along with the suffix: $diskcleanup>>. In addition or alternatively the component I.D. for the component could be used, resulting in a request to follow a category of entities defined as $36717>>. Along the same lines, the characters “<<” could be used as a suffix to indicate that a component may be followed as well as any preceding versions of it, as in $36717<<.

Micro blogging system 411 proceeds to identify those entities that may be relevant to the requested category (step 903). This may be accomplished in a variety of ways such as by, for example, examining the profile for each subject entity within micro blogging environment 413 to determine whether or not each entity falls into the category. Each subject entity—or any entity—may have an associated profiled stored within micro blogging environment 413 that describes its type, what software component it relates to, what group of components it belongs to, what product it belongs to, and the like. Note that a wide variety of information may be maintained within the profile such that a wide variety of categories may be supported.

Having identified the relevant subject entities, micro blogging system 411 associates those entities with user entity 425 such that user entity 425 may receive micro posts related to their activities (step 905). In this manner, user 445 need not submit multiple follow requests when desiring to follow a group of components. Rather, user 445 can submit a follow request for a category that then gets processed with respect to any subject entities that may satisfy the category.

FIG. 10 illustrates yet another micro documentation process 1000 in an implementation. Micro documentation process 1000 is also representative of some processes that may be performed by micro blogging system 411 when executing micro blog engine 412. In operation, micro blogging system 411 receives a request to follow a subject entity that is associated with a software component (step 1001). For example, user 445 operating communication device 434 to engage with view 435 may prompt communication device 434 to communicate a request on behalf of user entity 425 to follow a software component, such as the next version of the disk clean up component. However, the software component, and thus a corresponding subject entity, might not yet exist. Accordingly, micro blogging system 411 must first determine whether or not the subject entity exists (step 1003).

If the subject entity exists, then micro blogging system can establish user entity 425 as a follower of the subject entity and can post information on the subject entity to be consumed by at least user entity 425 (step 1009). But, if the subject entity does not yet exist, then micro blogging system monitors for its generation (step 1005). In this example, the next version of the disk clean up component is eventually created within software development system 401, triggering the creation of a corresponding subject entity within micro blogging environment 413 (step 1007). At that time, micro blogging system 411 can begin to generation micro posts on the subject entity for consumption by user entity 425.

FIG. 11 illustrates one operational sequence 1100 in an implementation that demonstrates how the various elements of micro documentation environment 400 may interact. Initially, a view of micro blogging environment 413 is communicated from micro blogging system 411 to client devices, such as communication device 434 and 436. Before, after, or at the same time, a software component is created in software development environment 403. Software development system 401 communicates this fact to micro blogging system 411, which in turn creates a corresponding entity. In this example it is assumed that the component I.D. for the recently created software component is 399589 and that the component is a bug. Thus, the name of the subject entity is *399589.

Later on, user 445 operating communication device 434 initiates a follow request to follow *355389. Micro blogging system 411 registers @andre as a follower of *355389. At a later point, @roberto publishes a micro post pertaining to *355389. Accordingly, micro blogging system 411 provides the micro post to communication device 434 within the view of micro blogging environment 413 for consumption by user 445. For instance, the micro post may be delivered within a personal feed.

Micro blogging system 411 also periodically or on some other basis communicates with software development system 401 to access documentation information related to the bug. For instance, the documentation information may convey the status of the bug, such as fixed or still outstanding. Software development system 401 provides a status update on the bug to micro blogging system 411. Micro blogging system 411 publishes the status update for consumption by any followers, which in this example includes at least @andre and @roberto.

FIG. 12 illustrates another operational sequence 1200 in an implementation that also demonstrates how the various elements of micro documentation environment 400 may interact in some scenarios. Initially, a view of micro blogging environment 413 is communicated from micro blogging system 411 to client devices, such as communication device 434 and 436. User 445 operating communication device 434 initiates a follow request to follow any bugs associated with a disk clean up component. Micro blogging system 411 registers this request, but at the present time no such bugs exists. Micro blogging system 411 therefore proceeds to monitor for the creation of such a software component within software development system 401.

Eventually a software component corresponding to the bug (such as a patch or fix) is created in software development environment 403. This fact is communicated to micro blogging system 411, which in turn can create a subject entity corresponding to the bug. In this example, it is assumed that the component corresponding to the bug has a component I.D. of 61908. Accordingly, the name of the subject entity is *61908. Later on, software development system 401 provides a status update on software component 61908 to micro blogging system 411. Micro blogging system 411 integrates the information from the status update into micro posts for consumption by followers of *61908, such as @andre.

FIG. 13 illustrates a productivity application 470, representative of any application viewed via display 499 on communication device 434 that may include a posting tool that allows users to post comments to a micro blog associated with a feature or component in the application. In particular, productivity application 470 includes various features 473-476 within a feature menu 472. Productivity application 470 also includes for exemplary purposes an application canvas 471 where text may be input or other work performed.

As a user works with productivity application 470, she may desire to post feedback on a particular component or features. Accordingly, productivity application 470 allows the user to click on, touch, or otherwise select a feature in such a manner as to trigger the presentation of a post interface 477. Post interface 477 presents a profile for the selected component that includes its component I.D., its name, and an associated product for exemplary purposes. A comment box is capable of receiving the user's comments and a post tool 478 can be selected to communicate the comments to micro blogging environment 413.

Micro blog environment 413 may then take the comments and publish them as a micro post in association with the subject entity associated with the selected component in the application. For example, the application used by the user may have been developed within software development system 401. Thus, components that make up the application may reside in or least be documented within software development system 401. Assuming that a subject entity exists that corresponds to the selected feature, micro blogging system 411 can generate and publish a micro post with the comments. In this manner, users interested in the particular feature can gain fast, real-time feedback from users of their application or their component.

Many aspects may be appreciated from the discussion of the various implementations, but may other aspects may also be appreciated in addition to those discussed above. For example, a micro documentation environment may serve to complement component specifications by capturing tribal and fine-grained knowledge. Such an online, collaborative and social-based infrastructure enables users to efficiently capture and retrieve unstructured documentation related to development entities such as components, bugs and test jobs, which are handled as first-class citizens in the micro documentation environment.

In some other implementations, generic micro-blogging hash tags (#) are now specialized to more semantically meaningful and customized tags, such as component tags, bug tags, test jobs tags, etc. In other words, organizations can define a tag syntax through which users can employ business-specific tags to annotate new micro posts with strongly-typed metadata. Instead of following only other people as typically happens in social networks, users can follow such first-class entities in order to receive their updates.

Cross-domain integration of development entities in the micro blogging context can be accomplished within a micro documentation environment. For example, a user can opt for following all bugs under a given component hierarchy. In addition, entity metadata can be incorporated as part of search and follow queries. For example, a user can search for all posts that mention test jobs for which he/she is the owner. Entities can be mapped from one version of the product to another. For example, when searching for all posts that mention a given Windows 7 component, users can opt for also receiving results related to up-level (Windows 8) and down-level (Windows Vista, XP, etc.) versions of the component. Incorporation of traditional component hierarchies into the micro blogging context can also be accomplished within a micro documentation environment. For instance, operations on the Personalization Control Panel component can be implicitly set to address its child Wallpaper and Themes sub-components as well.

Follow triggers can also be accomplished within a micro documentation environment. Follow triggers allow users to automatically follow business entities that have a new condition satisfied or even don't exist yet. For example, a test manager can set her corresponding entity to automatically follow new security incident bugs in her area.

Support for automated posts by other knowledge management tools and data sources can be provided by a micro documentation environment. For example, updates occurring in a bug database can be automatically posted to the micro blogging environment, with the appropriate bug and component tags. Note how specific business data sources can rely on the micro documentation environment, including the micro blogging environment, as a service through which organizational data can be made more evident and discoverable.

Likewise, micro posts can be entered into the system whenever a related development entity is created (e.g., a new linked bug is created in a different database, a test case is created for a given bug, or an article is published related to the bug). Finally, a user can determine that whenever a given topic is discussed in a given distribution list, it can appear as a micro-post in its personal feed. The contents related to a micro post's metadata, such as the contents of the first-class entities (component, bugs, etc.) and links mentioned in the micro post can be indexed. The indexed content can then be consumed by advanced search scenarios. For example, when searching for “access control”, users can receive back as results not only the micro posts with such terms, but also the micro posts that link to resources containing such terms.

Various technical advantages may be appreciated from the present discussion. For example, by hosting subject entities which a micro blogging environment that correspond to development entities, such as a software component, a user is able to more efficiently stay informed about various entities in which she is interested. In addition, the developer can follow the development entities within the same environment in which she follows colleagues, friends, and other developers. In another possible technical advantage, by integrating documentation information into a micro blogging environment, a developer may be spared from having to launch and operate a separate application platform as frequently as in the past in order to obtain the documentation information. This may contribute to improved device performance, such as enhanced battery life in the case of mobile devices, as well as other operating characteristics.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A micro documentation environment comprising:
a plurality of subject entities hosted within a micro blogging environment, the plurality of subject entities comprising a subject entity that corresponds to a software component of a plurality of software components within a software development environment;
a plurality of other entities hosted within the micro blogging environment, the plurality of other entities comprising a user entity configured to follow the subject entity; and
a plurality of micro posts generated and distributed within the micro blogging environment, the plurality of micro posts comprising a micro post generated on behalf of the subject entity and comprising documentation information related to the software component.

2. The micro documentation environment of claim 1 further comprising a micro blogging engine configured communicate with the software development environment to access and retrieve the documentation environment.

3. The micro documentation environment of claim 2 wherein the micro blogging engine is further configured to, in response to a request to follow an identified subject entity that does not yet exist, monitor for the creation of the identified subject entity.

4. The micro documentation environment of claim 1 wherein the plurality of subject entities further comprises another subject entity that corresponds to a development entity in the software development environment that is related to the software component.

5. The micro documentation environment of claim 1 wherein each of the plurality of subject entities is named in accordance with a naming syntax comprising a type portion and a component portion, wherein the type portion describes to which of a plurality of types each of the plurality of subject entities corresponds and wherein the component portion is preceded by the type portion and describes to which of a plurality of development entities each of the plurality of subject entities corresponds.

6. The micro documentation environment of claim 5 wherein the type portion in the naming syntax comprises an initial character that differs for each of the plurality of types and the component portion in the naming syntax comprises a string, wherein the plurality of types comprises a component, a bug, and a test job.

7. One or more computer readable storage media having program instructions stored thereon for facilitating a micro documentation environment comprising a micro blogging environment and a development environment that, when executed by a computing system, direct the computing system to at least:
receive a plurality of requests on behalf of a plurality of entities in the micro blogging environment to follow at least one other entity associated with at least one development entity of a plurality of development entities that reside in the development environment;
communicate with the development environment to access information related to the at least one development entity associated with the at least one other entity; and
include in each of a plurality of feeds distributed for consumption by the plurality of entities a micro post on the at least one other entity comprising the information related to the at least one development entity.

8. The one or more computer readable storage media of claim 7 wherein the program instructions further direct the computing system to represent the at least one other entity by an entity identifier named in accordance with a naming syntax comprising a type portion and a component portion.

9. The one or more computer readable storage media of claim 8 wherein the type portion describes to which of a plurality of types the at least one other entity corresponds and wherein the component portion is preceded by the type portion and describes to which of the plurality of development entities the at least one other entity corresponds.

10. The one or more computer readable storage media of claim 9 wherein the type portion in the naming syntax comprises an initial character and the component portion in the naming syntax comprises a string following the initial character, wherein the plurality of types comprises a component type, a bug type, and a test type, and wherein the initial character comprises a different symbol for each of the plurality of types.

11. The one or more computer readable storage media of claim 8 wherein the type portion describes to which of a plurality of types the at least one other entity corresponds and wherein the component portion is preceded by the type portion and describes to which of a plurality of groups the at least one other entity corresponds.

12. The one or more computer readable storage media of claim 8 wherein the program instructions further direct the computing system to auto-complete a query by translating at least a portion of a string describing one of the plurality of development entities to a corresponding entity identifier named in accordance with the naming syntax, wherein the component portion comprises a component identifier with which to access the information related to the one of the plurality of development entities.

13. The one or more computer readable storage media of claim 8 wherein the program instructions further direct the computing system to identify with which sub system of a plurality of sub systems within the development environment to communicate to access the information based on the type portion identified by each of the plurality of requests.

14. The one or more computer readable storage media of claim 7 wherein at least one request of the plurality of requests occurs prior to generation of the at least one other entity, wherein the program instructions further direct the computing system to:
monitor for the generation of the at least one other entity in response to the at least one request;
initiate the generation of the at least one other entity in response to an event occurring within the development environment associated with the at least one development entity; and
communicate with the development environment to access the information upon detecting the generation of the at least one other entity.

15. A method of operating a computing system to facilitate a micro documentation environment comprising a micro blogging environment and
a software development environment, the method comprising:
identifying a plurality of software components for representation within the micro blogging environment;
generating a plurality of subject entities associated with the plurality of software components;
communicating with the software development environment to access information related to each of the plurality of software components;
posting the information for consumption by followers of each of the plurality of subject entities associated with each of the plurality of software components.

16. The method of claim 15 further comprising representing each of the plurality of subject entities by an entity identifier named in accordance with a naming syntax comprising a type portion and a component portion, wherein the type portion describes to which of a plurality of types each of the plurality of subject entities corresponds and wherein the component portion describes to which of the plurality of software components each of the plurality of subject entities corresponds.

17. The method of claim 16 further comprising auto-completing a query by translating at least a portion of a string describing one of the plurality of software components to a corresponding entity identifier named in accordance with the naming syntax, wherein the component portion comprises a component identifier with which to access the information related to the one of the plurality of software components.

18. The method of claim 16 further comprising identifying with which sub system of a plurality of sub systems within the software development environment to communicate to access the information related to each of the plurality of software components based at least in part on the type portion of the entity identifier for each of the plurality of subject entities.

19. The method of claim 15 further comprising in response to a request to follow at least one entity of the plurality of subject entities associated with a software component not yet established in the software development environment, monitoring for the software component to be established.

20. The method of claim 14 further comprising publishing a micro post generated by a posting tool integrated within an application and associated with at least one of the plurality of software components for consumption by any followers of any of the plurality of subject entities associated with the at least one of the plurality of software components.
